(19) United States
(12) Patent Application Publication
(10) Pub. No.: US 2025/0068255 A1
(43) Pub. Date: Feb. 27, 2025

(54) Selective Touch Modes Based on Keyboard Input

(71) Applicant: Cirque Corporation, Sandy, UT (US)

(72) Inventor: Jon Bertrand, Taylorsville, UT (US)

(73) Assignee: Cirque Corporation, Sandy, UT (US)

(21) Appl. No.: 18/236,497

(22) Filed: Aug. 22, 2023

(51) Int. Cl. G06F 3/02; G06F 3/0354; G06F 3/041

(52) U.S. Cl. CPC G06F 3/0213; G06F 3/03547; G06F 3/04162; G06F 3/04166; G06F 3/0445; G06F 2203/04107

(57) ABSTRACT

A module may include a substrate; a plurality of capacitance electrodes on the substrate to form a capacitance sensor; a keyboard in communication with a controller, the plurality of capacitance electrodes in communication with the controller; memory in communication with the controller having programmed instructions that, when executed, cause the controller to receive a keyboard input; and operate a first portion of the capacitance sensor in a first mode while operating a second portion of the capacitance sensor in a second mode based on the keyboard input.

### FIELD OF THE DISCLOSURE

This disclosure relates generally to systems and methods for operating a capacitance sensor based on inputs on a keyboard. In particular, this disclosure relates to systems and methods for operating portions of a capacitance sensor in different modes based on inputs received on a keyboard.

### BACKGROUND

A touch pad is often incorporated into laptops and other devices to provide a mechanism for giving inputs to the device. For example, a touch pad may be positioned adjacent to a keyboard in a laptop and include a surface that can be touched by the user. Touch pads may operate using capacitive sensing, a technology that senses the change of capacitance where a finger touches the pad. In some examples, moving a finger, stylus, or another type of object adjacent on the touch pad may cause a cursor to move on a display in communication with the touch pad.

An example of a touch pad is disclosed in U.S. Pat. No. 7,400,318 issued to George Gerpheide, et al. This reference discloses a touch pad and measurement circuitry for enabling input to a computer or other electronic device. The system includes an X electrode, a Y electrode, a common sensing electrode, and a “water” electrode, wherein these four separate electrodes can be implemented in various physical configurations to obtain the desired effects, wherein moisture and water droplets can be identified and compensated for so as not to interfere with the input of data, wherein noise rejection is achieved by using a time aperture filtering method, wherein an improved scanning technique focuses scanning around an identified input object, wherein an adaptive motion filter responds to the speed and acceleration of an object being tracked, and wherein the measurement circuitry has an increased dynamic range enabling the touch pad to operate with greater tolerances to manufacturing variances. This reference is herein incorporated by reference for all that it contains.

A keyboard is often incorporated into laptops and other devices to provide a mechanism for giving inputs to the device. For example, a keyboard may be positioned adjacent to a touchpad in laptop and include a plurality of keys that may be pressed to input letters, numbers, symbols, or other commands to the laptop computer. In some examples, a keyboard may operate using electrical shorts as the main input mechanism. In some examples, a keyboard may also have capacitive components, have capacitive functionality, or be operated using capacitance.

An example of a keyboard is disclosed in U.S. Pat. No. 11,036,307 issued to John Green Elias, et al. This reference discloses a touch sensitive mechanical keyboard configured to enable a standard look and feel mechanical keyboard to sense fine hand/finger motion over the surface of the keys. Command and cursor input (e.g., pointing and gestures) can be received from the user on the touch sensitive mechanical keyboard without requiring the user to move the user's hand off the keyboard. Fine band/finger motion detection can be enabled by embedding clusters of capacitive sensors near the surface of the keyboard's keys. The touch sensitive mechanical keyboard can operate in two or more modes—e.g., a typing mode and a mouse mode—and operating the keyboard in mouse mode or switching between the modes can be facilitated by holding (depressing and holding) or tapping (depressing and releasing) arbitrary combinations of keys, or by detecting the number of fingers touching the touch sensitive mechanical keyboard.

Each of these references are herein incorporated by reference for all that they disclose.

### SUMMARY

In one embodiment, a module may include a substrate; a plurality of capacitance electrodes on the substrate to form a capacitance sensor; a keyboard in communication with a controller; the plurality of capacitance electrodes in communication with the controller; memory in communication with the controller having programmed instructions that, when executed, cause the controller to receive a keyboard input; and operate a first portion of the capacitance sensor in a first mode while operating a second portion of the capacitance sensor in a second mode based on the keyboard input.

The first mode may be an inactive mode and the second mode may be an active mode.

The first mode may be a modified mode that causes selective capacitance measurements to be interpreted differently than how the selective capacitance measurements may be interpreted under the second mode.

The location of the object may be determined by a keyboard input.

The location of the object may be determined with a capacitance measurement made with a circuit incorporated into the keyboard.

The programmed instructions may be further configured, when executed, to turn at least one of the pluralities of capacitance electrodes off.

The programmed instructions may be further configured, when executed, to cause the controller to ignore measurements from at least one of the pluralities of capacitance electrodes.

The plurality of capacitance electrodes may have a first group of electrodes and a second group of electrodes; and the groups of electrodes may be controlled independently with the controller.

The keyboard may be a capacitive input keyboard.

The first and second portions of the capacitance sensor may be a part of a plurality of portions of the capacitance sensor; and the plurality of portions may be operated in a plurality of modes based, at least in part, on inputs on the keyboard.

In some embodiments, a computer-program product for using a module, the computer-program product may have a non-transitory computer-readable medium storing instructions executable by a processor to receive a keyboard input; and send an instruction to operate a first portion of a capacitance sensor in a first mode while operating a second portion of the capacitance sensor in a second mode based on the keyboard input.

The first mode may be an inactive mode and the second mode may be an active mode.

The first mode may be a modified mode that causes selective capacitance measurements to be interpreted differently than how the selective capacitance measurements may be interpreted under the second mode.

The location of the object may be determined with a keyboard input.

The location of the object may be determined with a capacitance measurement made with a circuit incorporated into the keyboard.

In some embodiments, a method may include receiving a keyboard input; and sending an instruction to operate a first portion of a capacitance sensor in a first mode while operating a second portion of the capacitance sensor in a second mode based on the keyboard input.

The first mode may be an inactive mode and the second mode may be an active mode.

The first mode may be a modified mode that causes selective capacitance measurements to be interpreted differently than how the selective capacitance measurements may be interpreted under the second mode.

The location of the object may be determined by an input on the keyboard.

The location of the object may be determined with a capacitance measurement made with a circuit incorporated into the keyboard.

The location of a user hand may be determined, at least in part, on the keyboard input, and the keyboard input may be based on a capacitance measurement made with a circuit incorporated into the keyboard.

The location of a user hand may be determined, at least in part, on the keyboard input, and the keyboard input may be based on an electrical shorting measurement made with a circuit incorporated into the keyboard.

A capacitance module may include a substrate; a plurality of capacitance electrodes on the substrate to form a capacitance sensor; the plurality of capacitance electrodes in communication with a controller; memory in communication with the controller having programmed instructions that, when executed, cause the controller to: receive a keyboard input from a keyboard in communication with the controller; and operate a first portion of the capacitance sensor in a first mode while operating a second portion of the capacitance sensor in a second mode based on the keyboard input.

### BRIEF DESCRIPTION OF THE DRAWINGS

FIG. 1 depicts an example of an electronic device in accordance with the disclosure.

FIG. 2 depicts an example of a substrate with a first set of electrodes and a second set of electrodes in accordance with the disclosure.

FIG. 3 depicts an example of a touch pad in accordance with the disclosure.

FIG. 4 depicts an example of a touch screen in accordance with the disclosure.

FIG. 5 depicts an example of an input surface in accordance with the disclosure.

FIG. 6 depicts an example of an input surface in accordance with the disclosure.

FIG. 7 depicts an example of a keyboard input adjacent to a capacitance sensor in accordance with the disclosure.

FIG. 8 depicts an example of a keyboard input adjacent to a capacitance sensor in accordance with the disclosure.

FIG. 9 depicts an example of a keyboard input adjacent to a capacitance sensor in accordance with the disclosure.

FIG. 10 depicts an example of a table of capacitance sensor modes in accordance with the disclosure.

FIG. 11 depicts an example of a capacitance sensor in accordance with the disclosure.

FIG. 12 depicts an example of a capacitance sensor in accordance with the disclosure.

FIG. 13 depicts an example of a capacitance sensor in communication with a controller in accordance with the disclosure.

FIG. 14 depicts an example of a keyboard in communication with a controller in accordance with the disclosure.

FIG. 15 depicts an example of a method of operating a capacitance sensor in accordance with the disclosure.

FIG. 16 depicts an example of a method of operating a capacitance sensor in accordance with the disclosure.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION OF THE INVENTION

This description provides examples, and is not intended to limit the scope, applicability, or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted, or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

For purposes of this disclosure, the term “aligned” generally refers to being parallel, substantially parallel, or forming an angle of less than 35.0 degrees. For purposes of this disclosure, the term “transverse” generally refers to perpendicular, substantially perpendicular, or forming an angle between 55.0 and 125.0 degrees. For purposes of this disclosure, the term “length” generally refers to the longest dimension of an object. For purposes of this disclosure, the term “width” generally refers to the dimension of an object from side to side and may refer to measuring across an object perpendicular to the object's length.

For purposes of this disclosure, the term “electrode” may generally refer to a portion of an electrical conductor intended to be used to make a measurement, and the terms “route” and “trace” generally refer to portions of an electrical conductor that are not intended to make a measurement. For purposes of this disclosure in reference to circuits, the term “line” generally refers to the combination of an electrode and a “route” or “trace” portions of the electrical conductor. For purposes of this disclosure, the term “Tx” generally refers to a transmit line, electrode, or portions thereof, and the term “Rx” generally refers to a sense line, electrode, or portions thereof.

For the purposes of this disclosure, the term “electronic device” may generally refer to devices that can be transported and include a battery and electronic components. Examples may include a laptop, a desktop, a mobile phone, an electronic tablet, a personal digital device, a watch, a gaming controller, a gaming wearable device, a wearable device, a measurement device, an automation device, a security device, a display, a computer mouse, a vehicle, an infotainment system, an audio system, a control panel, another type of device, an athletic tracking device, a tracking device, a card reader, a purchasing station, a kiosk, or combinations thereof.

It should be understood that use of the terms “capacitance module,” “touch pad” and “touch sensor” throughout this document may be used interchangeably with “capacitive touch sensor,” “capacitive sensor,” “capacitance sensor,” “capacitive touch and proximity sensor,” “proximity sensor,” “touch and proximity sensor,” “touch panel,” “trackpad,” “touch pad,” and “touch screen.” The capacitance module may be incorporated into an electronic device.

It should also be understood that, as used herein, the terms “vertical,” “horizontal,” “lateral,” “upper,” “lower,” “left,” “right,” “inner,” “outer,” etc., can refer to relative directions or positions of features in the disclosed devices and/or assemblies shown in the Figures. For example, “upper” or “uppermost” can refer to a feature positioned closer to the top of a page than another feature. These terms, however, should be construed broadly to include devices and/or assemblies having other orientations, such as inverted or inclined orientations where top/bottom, over/under, above/below, up/down, and left/right can be interchanged depending on the orientation.

In some cases, the capacitance module is located within a housing. The capacitance module may be underneath the housing and capable of detecting objects outside of the housing. In examples, where the capacitance module can detect changes in capacitance through a housing, the housing is a capacitance reference surface. For example, the capacitance module may be disclosed within a cavity formed by a keyboard housing of a computer, such as a laptop or other type of computing device, and the sensor may be disposed underneath a surface of the keyboard housing. In such an example, the keyboard housing adjacent to the capacitance module is the capacitance reference surface. In some examples, an opening may be formed in the housing, and an overlay may be positioned within the opening. In this example, the overlay is the capacitance reference surface. In such an example, the capacitance module may be positioned adjacent to a backside of the overlay, and the capacitance module may sense the presence of the object through the thickness of the overlay. For the purposes of this disclosure, the term “reference surface” may generally refer to a surface through which a pressure sensor, a capacitance sensor, or another type of sensor is positioned to sense a pressure, a presence, a position, a touch, a proximity, a capacitance, a magnetic property, an electric property, another type of property, or another characteristic, or combinations thereof that indicates an input. For example, the reference surface may be a housing, an overlay, or another type of surface through which the input is sensed. In some examples, the reference surface has no moving parts. In some examples, the reference surface may be made of any appropriate type of material, including, but not limited to, plastics, glass, a dielectric material, a metal, another type of material, or combinations thereof.

For the purposes of this disclosure, the term “display” may generally refer to a display or screen that is not depicted in the same area as the capacitive reference surface. In some cases, the display is incorporated into a laptop where a keyboard is located between the display and the capacitive reference surface. In some examples where the capacitive reference surface is incorporated into a laptop, the capacitive reference surface may be part of a touch pad. Pressure sensors may be integrated into the stack making up the capacitance module. However, in some cases, the pressure sensors may be located at another part of the laptop, such as under the keyboard housing, but outside of the area used to sense touch inputs, on the side of the laptop, above the keyboard, to the side of the keyboard, at another location on the laptop, or at another location. In examples where these principles are integrated into a laptop, the display may be pivotally connected to the keyboard housing. The display may be a digital screen, a touch screen, another type of screen, or combinations thereof. In some cases, the display is located on the same device as the capacitive reference surface, and in other examples, the display is located on another device that is different from the device on which the capacitive reference surface is located. For example, the display may be projected onto a different surface, such as a wall or projector screen. In some examples, the reference surface may be located on an input or gaming controller, and the display is located on a wearable device, such as a virtual reality or augmented reality screen. In some cases, the reference surface and the display are located on the same surface, but on separate locations on that surface. In other examples, the reference surface and the display may be integrated into the same device, but on different surfaces. In some cases, the reference surface and the display may be oriented at different angular orientations with respect to each other.

For the purposes of this disclosure, the term “keyboard input” may generally refer to an input on a keyboard that sends a specific electrical signal to a controller in communication with the keyboard. In some examples, a keyboard input may send a signal to a controller to indicate that a certain key on the keyboard has been pressed. In some examples, a controller in communication with the keyboard may determine the key, the location of the key, the length of the press on the key, the pressure exerted on the key, another property of the input, or a combination thereof. In some examples, the keyboard input may correspond to an electrical short created by a key being pressed and making contact with an array of contacts on the keyboard. In other examples, a keyboard input may correspond to a capacitive reading on the grid of contacts based on an object moving proximate the keyboard. In some examples, the keyboard is a separate input device from the capacitance module. In some cases, a controller controlling an operation of the keyboard is independent of another controller that controls the operation of the capacitance module. In some cases, the location of the keyboard input may determine the mode for the touch inputs. In some examples, the location of the keyboard input may determine which portion of the capacitance module operates in a different mode. For example, keyboard inputs for buttons located forward of (e.g., towards the display of the laptop) and near the right side of the capacitance module may cause the capacitance module to switch a different mode on just the right portion of the capacitance module.

For the purposes of this disclosure, the term “capacitive input keyboard” may generally refer to a keyboard that receives inputs based on capacitive signals from an object moving proximate to the keyboard. In some examples, a capacitive input keyboard may be integrated into a touch screen device. In some examples, a capacitive keyboard may change size, shape, or location based on inputs from a controller in communication with the keyboard. In some examples, a capacitive input keyboard may determine the location, magnitude, velocity, another property, or a combination thereof, of a capacitive input of an object moving proximate to the capacitive input keyboard.

For the purposes of this disclosure, the term “active mode” may generally refer to a mode of operation in which a portion of a capacitance sensor is receiving capacitance inputs and the inputs are being outputted from a controller in communication with the capacitance sensor.

For the purposes of this disclosure, the term “inactive mode” may generally refer to a mode of operation in which a portion of a capacitance sensor is not receiving capacitance inputs, or the received inputs are not being outputted from a controller in communication with the capacitance sensor. In some examples, the controller may be receiving signals from the capacitance sensor, but the controller is not outputting the signals to other systems. In some examples, the sensor may have one or more electrodes that are powered off. In some examples, electrical signals outputted by the capacitance sensor may be ignored by the controller.

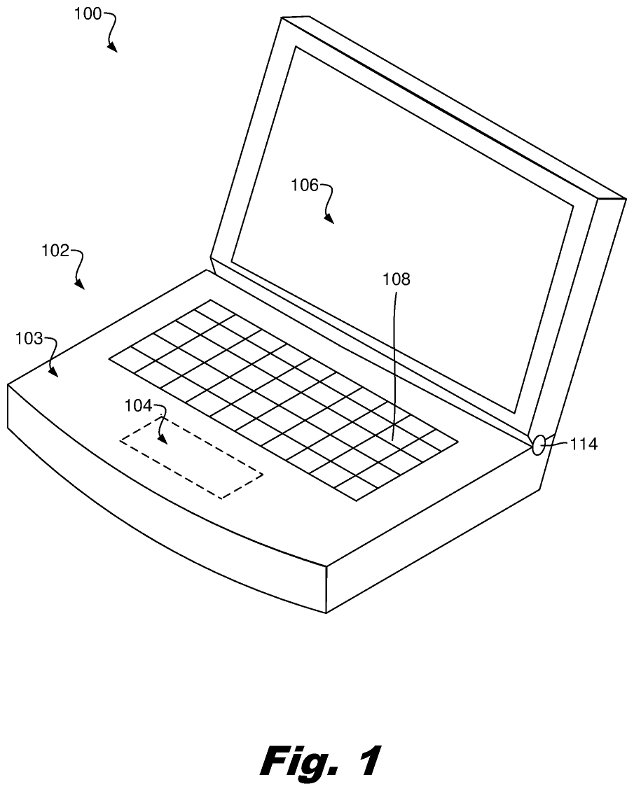

FIG. 1 depicts an example of an electronic device 100. In this example, the electronic device is a laptop. In the illustrated example, the electronic device 100 includes input components, such as a keyboard 102 and a capacitive module, such as a touch pad 104, that are incorporated into a housing 103. The electronic device 100 also includes a display 106. A program operated by the electronic device 100 may be depicted in the display 106 and controlled by a sequence of instructions that are provided by the user through the keyboard 102 and/or through the touch pad 104. An internal battery (not shown) may be used to power the operations of the electronic device 100.

The keyboard 102 includes an arrangement of keys 108 that can be individually selected when a user presses on a key with a sufficient force to cause the key 108 to be depressed towards a switch located underneath the keyboard 102. In response to selecting a key 108, a program may receive instructions on how to operate, such as a word processing program determining which types of words to process. A user may use the touch pad 104 to give different types of instructions to the programs operating on the computing device 100. For example, a cursor depicted in the display 106 may be controlled through the touch pad 104. A user may control the location of the cursor by sliding his or her hand along the surface of the touch pad 104. In some cases, the user may move the cursor to be located at or near an object in the computing device's display and give a command through the touch pad 104 to select that object. For example, the user may provide instructions to select the object by tapping the surface of the touch pad 104 one or more times.

The touch pad 104 is a capacitance module that includes a stack of layers disposed underneath the keyboard housing, underneath an overlay that is fitted into an opening of the keyboard housing, or underneath another capacitive reference surface. In some examples, the capacitance module is located in an area of the keyboard's surface where the user's palms may rest while typing. The capacitance module may include a substrate, such as a printed circuit board or another type of substrate. One of the layers of the capacitance module may include a sensor layer that includes a first set of electrodes oriented in a first direction and a second layer of electrodes oriented in a second direction that is transverse the first direction. These electrodes may be spaced apart and/or electrically isolated from each other. The electrical isolation may be accomplished by depositing at least a portion of the electrodes on different sides of the same substrate or providing dedicated substrates for each set of electrodes. Capacitance may be measured at the overlapping intersections between the different sets of electrodes. However, as an object with a different dielectric value than the surrounding air (e.g., finger, stylus, etc.) approaches the intersections between the electrodes, the capacitance between the electrodes may change. This change in capacitance and the associated location of the object in relation to the capacitance module may be calculated to determine where the user is touching or hovering the object within the detection range of the capacitance module. In some examples, the first set of electrodes and the second set of electrodes are equidistantly spaced with respect to each other. Thus, in these examples, the sensitivity of the capacitance module is the same in both directions. However, in other examples, the distance between the electrodes may be non-uniformly spaced to provide greater sensitivity for movements in certain directions.

In some cases, the display 106 is mechanically separate and movable with respect to the keyboard with a connection mechanism 114. In these examples, the display 106 and keyboard 102 may be connected and movable with respect to one another. The display 106 may be movable within a range of 0 degrees to 180 degrees or more with respect to the keyboard 102. In some examples, the display 106 may fold over onto the upper surface of the keyboard 102 when in a closed position, and the display 106 may be folded away from the keyboard 102 when the display 106 is in an operating position. In some examples, the display 106 may be orientable with respect to the keyboard 102 at an angle between 35 to 135 degrees when in use by the user. However, in these examples, the display 106 may be positionable at any angle desired by the user.

In some examples, the display 106 may be a non-touch sensitive display. However, in other examples at least a portion of the display 106 is touch sensitive. In these examples, the touch sensitive display may also include a capacitance module that is located behind an outside surface of the display 106. As a user's finger or other object approaches the touch sensitive screen, the capacitance module may detect a change in capacitance as an input from the user.

While the example of FIG. 1 depicts an example of the electronic device being a laptop, the capacitance sensor and touch surface may be incorporated into any appropriate device. A non-exhaustive list of devices includes, but is not limited to, a desktop, a display, a screen, a kiosk, a computing device, an electronic tablet, a smart phone, a location sensor, a card reading sensor, another type of electronic device, another type of device, or combinations thereof.

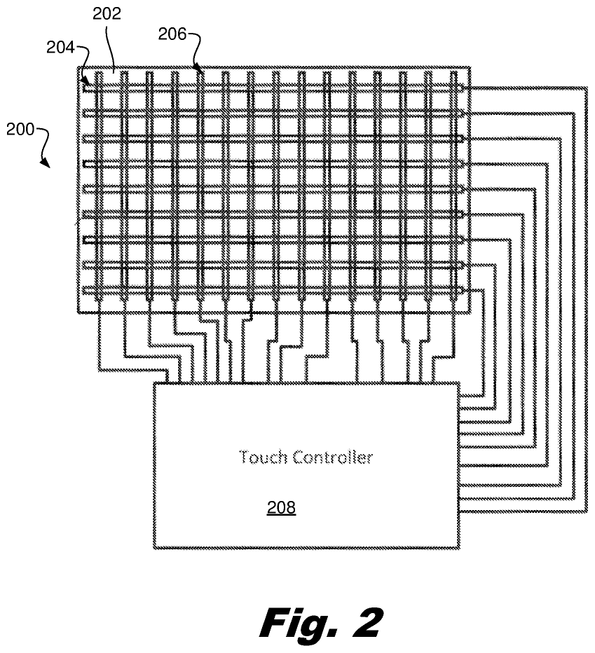

FIG. 2 depicts an example of a portion of a capacitance module 200. In this example, the capacitance module 200 may include a substrate 202, first set 204 of electrodes, and a second set 206 of electrodes. The first and second sets 204, 206 of electrodes may be oriented to be transverse to each other. Further, the first and second sets 204, 206 of electrodes may be electrically isolated from one another so that the electrodes do not short to each other. However, where electrodes from the first set 204 overlap with electrodes from the second set 206, capacitance can be measured. The capacitance module 200 may include one or more electrodes in the first set 204 or the second set 206. Such a substrate 202 and electrode sets may be incorporated into a touch screen, a touch pad, a location sensor, a gaming controller, a button, and/or detection circuitry.

In some examples, the capacitance module 200 is a mutual capacitance sensing device. In such an example, the substrate 202 has a set 204 of row electrodes and a set 206 of column electrodes that define the touch/proximity-sensitive area of the component. In some cases, the component is configured as a rectangular grid of an appropriate number of electrodes (e.g., 8-by-6, 16-by-12, 9-by-15, or the like).

As shown in FIG. 2, the capacitance module 208 includes a capacitance controller 208. The capacitance controller 208 may include at least one of a central processing unit (CPU), a digital signal processor (DSP), an analog front end (AFE) including amplifiers, a peripheral interface controller (PIC), another type of microprocessor, and/or combinations thereof, and may be implemented as an integrated circuit, a field programmable gate array (FPGA), an application specific integrated circuit (ASIC), a combination of logic gate circuitry, other types of digital or analog electrical design components, or combinations thereof, with appropriate circuitry, hardware, firmware, and/or software to choose from available modes of operation.

In some cases, the capacitance controller 208 includes at least one multiplexing circuit to alternate which of the sets 204, 206 of electrodes are operating as drive electrodes and sense electrodes. The driving electrodes can be driven one at a time in sequence, or randomly, or drive multiple electrodes at the same time in encoded patterns. Other configurations are possible such as a self-capacitance mode where the electrodes are driven and sensed simultaneously.

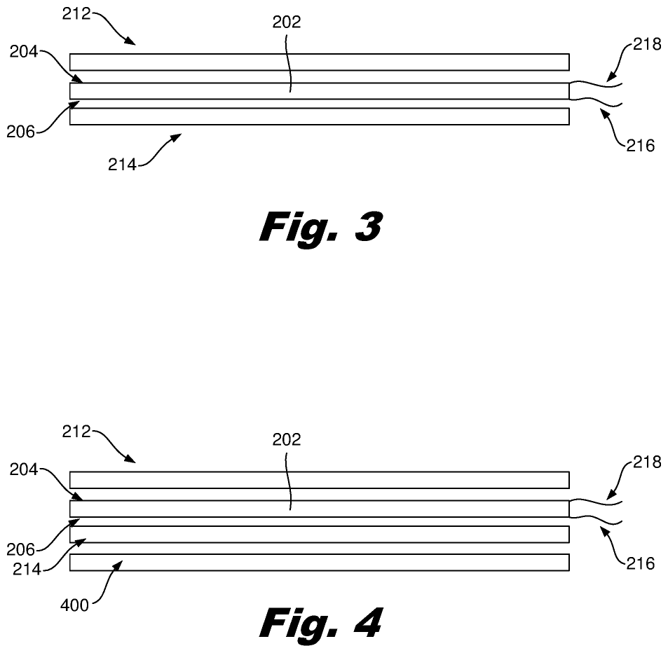

Electrodes may also be arranged in non-rectangular arrays, such as radial patterns, linear strings, or the like. A shield layer (see FIG. 3) may be provided beneath the electrodes to reduce noise or other interference. The shield may extend beyond the grid of electrodes. Other configurations are also possible.

In some cases, no fixed reference point is used for measurements. The touch controller 208 may generate signals that are sent directly to the first or second sets 204, 206 of electrodes in various patterns.

In some cases, the component does not depend upon an absolute capacitive measurement to determine the location of a finger (or stylus, pointer, or other object) on a surface of the capacitance module 200. The capacitance module 200 may measure an imbalance in electrical charge to the electrode functioning as a sense electrode which can, in some examples, be any of the electrodes designated in either set 204, 206 or, in other examples, with dedicated-sense electrodes. When no pointing object is on or near the capacitance module 200, the capacitance controller 208 may be in a balanced state, and there is no signal on the sense electrode. When a finger or other pointing object creates imbalance because of capacitive coupling, a change in capacitance may occur at the intersections between the sets of electrodes 204, 206 that make up the touch/proximity sensitive area. In some cases, the change in capacitance is measured. However, in an alternative example, the absolute capacitance value may be measured.

While this example has been described with the capacitance module 200 having the flexibility of the switching the sets 204, 206 of electrodes between sense and transmit electrodes, in other examples, each set of electrodes is dedicated to either a transmit function or a sense function.

FIG. 3 depicts an example of a substrate 202 with a first set 204 of electrodes and a second set 206 of electrodes deposited on the substrate 202 that is incorporated into a capacitance module. The first set 204 of electrodes and the second set 206 of electrodes may be spaced apart from each other and electrically isolated from each other. In the example depicted in FIG. 3, the first set 204 of electrodes is deposited on a first side of the substrate 202, and the second set 206 of electrodes is deposited on the second side of the substrate 202, where the second side is opposite the first side and spaced apart by the thickness of the substrate 202. The substrate may be made of an electrically insulating material thereby preventing the first and second sets 204, 206 of electrodes from shorting to each other. As depicted in FIG. 2, the first set 204 of electrodes and the second set 206 of electrodes may be oriented transversely to one another. Capacitance measurements may be taken where the intersections with the electrodes from the first set 204 and the second set 206 overlap. In some examples, a voltage may be applied to the transmit electrodes and the voltage of a sense electrode that overlaps with the transmit electrode may be measured. The voltage from the sense electrode may be used to determine the capacitance at the intersection where the sense electrode overlaps with the transmit electrode.

In the example of FIG. 3 depicting a cross section of a capacitance module, the substrate 202 may be located between a capacitance reference surface 212 and a shield 214. The capacitance reference surface 212 may be a covering that is placed over the first side of the substrate 202 and that is at least partially transparent to electric fields. As a user's finger or stylus approaches the capacitance reference surface 212, the presence of the finger or the stylus may affect the electric fields on the substrate 202. With the presence of the finger or the stylus, the voltage measured from the sense electrode may be different than when the finger or the stylus are not present. As a result, the change in capacitance may be measured.

The shield 214 may be an electrically conductive layer that shields electric noise from the internal components of the electronic device. This shield may prevent influence on the electric fields on the substrate 202. In some cases, the shield is a solid piece of material that is electrically conductive. In other cases, the shield has a substrate and an electrically conductive material disposed on at least one substrate. In yet other examples, the shield is layer in the touch pad that performs a function and also shields the electrodes from electrically interfering noise. For example, in some examples, a pixel layer in display applications may form images that are visible through the capacitance reference surface, but also shields the electrodes from the electrical noise.

The voltage applied to the transmit electrodes may be carried through an electrical connection 216 from the touch controller 208 to the appropriate set of electrodes. The voltage applied to the sense electrode through the electric fields generated from the transmit electrode may be detected through the electrical connection 218 from the sense electrodes to the touch controller 208.

While the example of FIG. 3 has been depicted as having both sets of electrodes deposited on a substrate, one set of electrodes deposited on a first side and a second set of electrodes deposited on a second side; in other examples, each set of electrodes may be deposited on its own dedicated substrate.

Further, while the examples above describe a touch pad with a first set of electrodes and a second set of electrodes; in some examples, the capacitance module has a single set of electrodes. In such an example, the electrodes of the sensor layer may function as both the transmit and the receive electrodes. In some cases, a voltage may be applied to an electrode for a duration of time, which changes the capacitance surrounding the electrode. At the conclusion of the duration of time, the application of the voltage is discontinued. Then a voltage may be measured from the same electrode to determine the capacitance. If there is no object (e.g., finger, stylus, etc.) on or in the proximity of the capacitance reference surface, then the measured voltage off of the electrode after the voltage is discontinued may be at a value that is consistent with a baseline capacitance. However, if an object is touching or in proximity to the capacitance reference surface, then the measured voltage may indicate a change in capacitance from the baseline capacitance.

In some examples, the capacitance module has a first set of electrodes and a second set of electrodes and is communication with a controller that is set up to run both mutual capacitance measurements (e.g., using both the first set and the second set of electrodes to take a capacitance measurement) or self-capacitance measurements (e.g., using just one set of electrodes to take a capacitance measurement).

FIG. 4 depicts an example of a capacitance module incorporated into a touch screen. In this example, the substrate 202, sets of electrodes 204, 206, and electrical connections 216, 218 may be similar to the arrangement described in conjunction with FIG. 3. In the example of FIG. 4, the shield 214 is located between the substrate 202 and a display layer 400. The display layer 400 may be a layer of pixels or diodes that illuminate to generate an image. The display layer may be a liquid crystal display, a light emitting diode display, an organic light emitting diode display, an electroluminescent display, a quantum dot light emitting diode display, an incandescent filaments display, a vacuum florescent display, a cathode gas display, another type of display, or combinations thereof. In this example, the shield 214, the substrate 202, and the capacitance reference surface 212 may all be at least partially optically transparent to allow the image depicted in the display layer to be visible to the user through the capacitance reference surface 212. Such a touch screen may be included in a monitor, a display assembly, a laptop, a mobile phone, a mobile device, an electronic tablet, a dashboard, a display panel, an infotainment device, another type of electronic device, or combinations thereof.

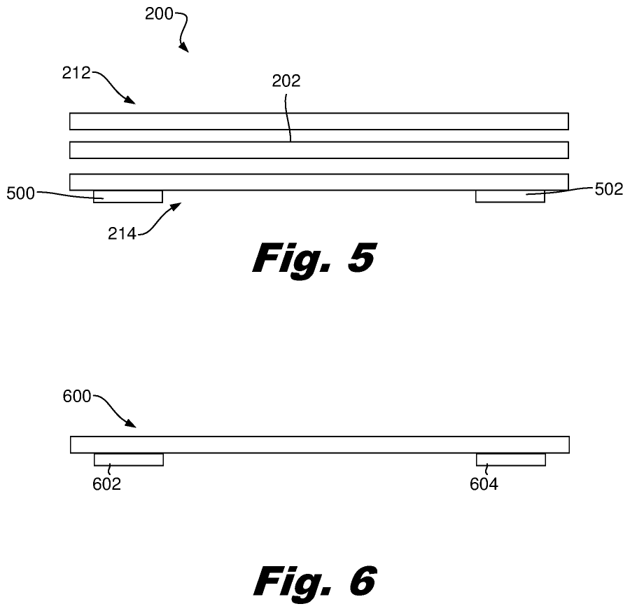

FIG. 5 depicts an example of a cross section of a capacitance module 200 where the substrate 202 may be located between a capacitance reference surface 212 and a shield 214. In this example, a first pressure sensor 500 and a second pressure sensor 502 are incorporated into the capacitance module pad 200. As depicted in this example, the pressure sensors 500, 502 may be disposed adjacent to an underside of the shield 214. But, in other examples, the pressure sensors may be positioned at any appropriate location, including, but not limited to, adjacent the underside of the capacitance reference surface 212, adjacent the underside of the shield, adjacent the underside of the substrate 202, another location, or combinations thereof. In examples where the pressure sensors 500, 502 are positioned under the substrate 202, pressure applied to the capacitance reference surface 212 may be transmitted through the capacitance reference surface 212 exerting a pressure on the substrate 202, which in turn applies a pressure to at least one of the pressure sensors 500, 502. In examples where the pressure sensors are positioned adjacent to the shield, the pressure applied to input surface may be transmitted to the shield, which in turn applies the pressure to the pressure sensors. This pressure may be measured by the pressure sensors 500, 502 to determine the value of the pressure. In this example, the first pressure sensor 500 is spaced apart from the second pressure sensor 502 at a distance along a length, width, and/or another dimension of the capacitance reference surface 212, which may allow the first pressure sensor 500 and the second pressure 502 to detect different levels of pressure depending on the location where the pressure input is made on the capacitance reference surface 212. In some cases, those pressure sensors that are closer to the location where the pressure input is made can detect a greater pressure force than the pressure sensor that is located farther away. The differing pressure values may help determine where the pressure input is made.

While this example is depicted with a pressure sensor incorporated into a capacitance module with a capacitance sensor, in other examples, the pressure sensors are not incorporated with a capacitance sensor. Further, any appropriate type of pressure sensor may be used in accordance with the principles described herein. For example, a non-exhaustive list of suitable pressure sensors includes, but is not limited to, piezoelectric sensors, magnostrictive sensors, potentiometric pressure sensors, inductive pressure sensors, capacitive pressure sensors, strain gauge pressure sensors, variable reluctance pressure sensors, other types of pressure sensors, or combinations thereof.

In some examples, the pressure sensor may also include an ability to provide haptic feedback. For example, a piezoelectric device may be used as both a pressure sensor and as a haptic device. When the piezoelectric material is compressed due to the application of pressure through the capacitance reference surface, the piezoelectric material may produce an electric signal with can be detected by a controller. In some cases, the controller may produce an electric signal that is sent to the piezoelectric material to cause the piezoelectric material to expand, contract, and/or vibrate. The vibrations from the piezoelectric material may cause the capacitance reference surface to vibrate. This vibration may communicate a haptic signal to the user. However, in some examples, the pressure sensors are not configured to provide a haptic signal.

FIG. 6 depicts an example of a reference surface 600. In this example, a first pressure sensor 602 and a second pressure sensor 604 are located adjacent to the reference surface 600. In this example, the first pressure sensor 602 and the second pressure sensor 604 are not incorporated into a stack having a capacitance sensor.

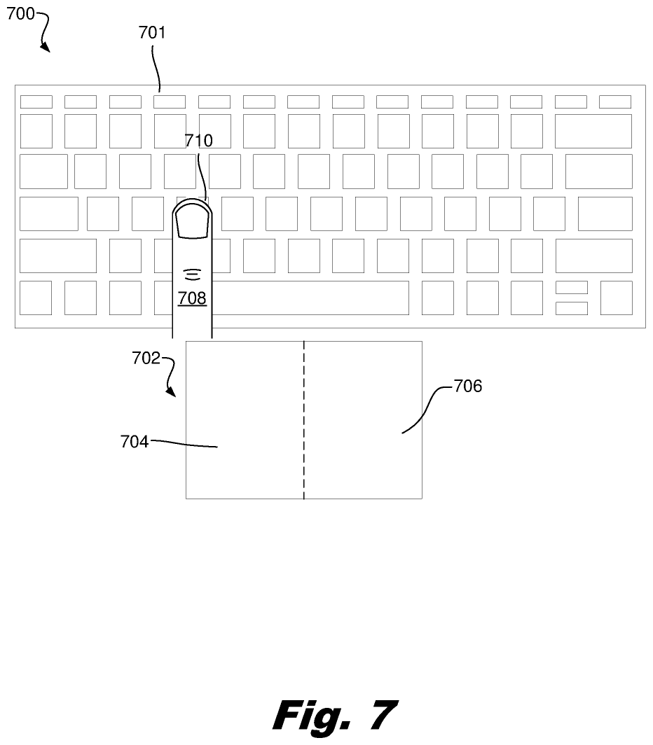

FIG. 7 depicts an example of an electronic device 700, which includes a keyboard 701 that is positioned near a capacitance sensor 702. The capacitance sensor has a first portion 704 and a second portion 706. A user input may include a finger 708 pressing a key 710 of the keyboard 701. A controller in communication with the keyboard and/or the capacitance sensor may receive an input related to the finger 708 pressing the key 710. In some examples, the controller may change the mode of one or both of the portions 704, 706 of the capacitance sensor 702. In some examples, when the controller receives the input of the finger 708 pressing the key 710, the controller may change the first portion 704 of the capacitance sensor to an inactive mode. In some examples, the second portion 706 may continue to operate in an active mode while the first portion 704 operates in the inactive mode.

In some examples, a controller in communication with the keyboard 701 and the capacitance sensor 702 may determine the modes of the portions 704, 706 of the capacitance sensor 702 based, at least in part, on inputs on the keyboard. In some examples, any key press on a portion of the keyboard near to a portion of the capacitance sensor may cause that portion of the capacitance sensor 702 to change modes. For example, if an input is detected on the keyboard corresponding to a key that is adjacent to the second portion 706 of the capacitance controller 702, the second portion 706 may change modes. In some examples, any key presses to the right of a predetermined set of keys may change the mode of the second portion 706 of the capacitance sensor 702 and any key presses to the left of a predetermined set of keys may change the mode of the first portion 704 of the capacitance sensor 702.

In some examples, switching modes of at least one of the portions of the capacitance sensor may appear to the user to deactivate the capacitance sensor. In some cases, the first mode may cause the controller to stop processing inputs to that portion of the capacitance sensor, stop activating sense electrodes of that portion of the capacitance sensor, stop taking measurements with that portion of the capacitance sensor, stop sending outputs from the controller associated with that portion of the controller, stop sending transmit signals to that portion of the capacitance sensor, execute another event that causes that portion of the capacitance sensor to appear deactivated, or combinations thereof.

In some examples, the keyboard 701 may operate using electrical shorts. In some examples, when a key is pressed, a conductive terminal on the underside of the key may contact an electrically charged grid and create an electrical short. In some examples, this electrical short may be detected by a controller in communication with the keyboard as a press input. In some examples, a capacitive measurement may be detectable on the electrical grid before a short is initiated by a key press. In some examples, a finger moving proximate the electrical grid of the keyboard may affect the capacitance measurement on the electrical grid. For example, if a finger is positioned on or adjacent to a key of the keyboard, a controller in communication with the keyboard may determine that the capacitance at a location of the keyboard corresponding to the key has changed. In such an example, the controller may determine that the finger is positioned adjacent to the key even if the key is not pressed.

In some examples, a controller in communication with the keyboard 701 and/or the capacitance sensor 702 may detect a capacitance measurement on the keyboard 701. In some examples, the controller may change the mode of portions 704, 706 of the capacitance sensor 702 based, at least in part, on the capacitance measurement on the keyboard 701. For example, on a standard English keyboard, the “a” key may generally be found on the left of the keyboard. If a finger is capacitively detected adjacent to the “a” key, a controller in communication with the keyboard may determine that a finger is positioned on or adjacent to that key. The controller may determine that an input detected on the left side of the capacitance sensor may be ignored based, at least in part, on the detected position of the finger.

In some examples, a controller in communication with the capacitance sensor 702 may change the mode of the portions 704, 706 of the capacitance sensor 702. In some examples, the mode of the portions may be changed in response to detecting an electrical change on a key and/or portion of the keyboard. In some examples, the controller may electrically turn off one of the portions 704, 706. In some examples, the controller may ignore inputs on one of the portions 704, 706. In some examples, the controller may change how the controller interprets inputs on the portions 704, 706. In some examples, the controller may change the sensitivity of the portions 704, 706 of the capacitance sensor 702. In some examples, the controller may change the priority of received inputs on the portions 704,706.

In some examples, a controller in communication with the capacitance sensor 702 may change a portion of the sensor to be in palm detection mode. In palm detection mode, a portion of the sensor may interpret an input with certain characteristics as a palm of a hand. For example, some measurements made by the capacitance sensor that depict a palm resting on a portion of the capacitance sensing region of the working surface of the laptop (which is adjacent to the capacitance sensor) may be close to other measurements made by the capacitance sensor which depict touch commands. In some examples, it may be difficult to distinguish whether such measurements depict a touch command or a palm resting in the touch sensitive area. In such situations, the keyboard input may cause the mode of the capacitance sensor to change such that the controller includes an additional factor that the user is operating the keyboard, which may cause the controller to determine that the keyboard input is a palm resting in the touch sensitive area.

In some gaming applications, the user may rest one of the palms of his hand over a first portion of the capacitance sensor to frequently use a select group of command keys of the keyboard to instruct the gaming program. At the same time, the user may provide touch inputs to the other portions of the capacitance sensor to provide additional inputs to the gaming program. Thus, the system may put a first portion of the capacitance module in a mode that is adjusted to minimize the use of the capacitance sensor while still allowing the other portion of the capacitance sensor to operate in a touch mode so that the user can make both keyboard commands while resting a palm in the touch sensitive area and capacitance commands at the same time, just on a different portion of the same capacitance sensor.

In some examples, a controller in communication with the capacitance sensor 702 may change how the controller interprets inputs on the capacitance sensor 702 based, at least in part, from inputs received on the keyboard 701. In some examples, the controller may change the interpretation of inputs on the capacitance sensor based, at least in part, on the size, duration, shape, movement, another property, and/or a combination thereof, of inputs on the capacitance sensor. For example, if an input on the keyboard 701 is detected adjacent to a portion 704, 706 of the capacitance sensor, a controller may interpret inputs on that portion differently than if there were no inputs on the keyboard. For example, if a finger is positioned on the left side of the keyboard, an input on the left portion of the capacitance sensor may be interpreted as a palm, instead of as a movement input. The input on the capacitance sensor may be larger, stay in the same or substantially the same position for a longer period of time, or have another feature of the input differing from a movement input or press input.

For example, in applications where the user is typing with a keyboard, a series of keyboard inputs may be received at the capacitance controller. In such examples, the controller may cause the mode to switch in those portions of the capacitance module that are likely to be associated with a palm resting on it when those keys are used by the user. In some cases, the mode does not switch until the stream of keyboard inputs has reached a predetermined amount of time. In some cases, there must be a predetermined amount of keyboard inputs received within a predetermined amount of time. In some cases, the controller may cause the mode of the appropriate portion to switch when a continuous or mostly continuous input is received with the controller. In such an example, the keyboard may use a capacitance sensor integrated into the keyboard to determine the position of the user's hand. If the user's hand is detected hovering over the keyboard for a predetermined amount of time, the controller may cause the mode to switch. In some cases, the mode may not switch if the user merely makes just a couple of keyboard inputs or the user's hand is detected to be over the keyboard for just a couple of seconds. In some cases, if the user's hand is relatively stationary over the keyboard for a number of seconds or another predetermined amount of time, the associated portions of the capacitance sensor may switch modes. In some examples, the mechanical structure of the keyboard's transmit line in a first layer of the keyboard and sense line in a second layer of the keyboard may be used to measure a capacitance of the finger over the keyboard. In this example, a capacitance keyboard measurement may be used to determine the position of the user's hands and change the mode of the appropriate portion of the capacitance module.

In the depicted example, the capacitance sensor is divided into a first portion 704 and a second portion 706. In other examples, the capacitance sensor may be divided into three portions, four portions or any appropriate number of portions. In some examples, the capacitance sensor may be divided along the length of the sensor. In some examples, the sensor may be divided along the width of the sensor. In some examples, the different portions have similar dimensions. However, in other examples, the portions may include different lengths, widths, shapes, and/or other dimensions.

In some examples, a capacitance sensor may have electrodes positioned in a transverse row and column pattern. For example, a capacitance sensor may have 8 electrodes (column electrodes) that run along a width of the sensor and 6 electrodes (row electrodes) that run along a length of the capacitance sensor. These electrodes may operate using mutual capacitance to sense an object moving proximate to the capacitance sensor. In some examples, the row electrodes may be transmit electrodes and the column electrodes may be sense electrodes. In other examples, the row electrodes may be sense electrodes and the column electrodes may be transmit electrodes. In some examples, the column electrodes may be controlled in two groups. In such an example, one set of column electrodes may transmit while the other group may be deactivated. For example, if a key on a keyboard near the capacitance sensor is pressed that is near to one of the sets of electrodes, that set of electrodes may be deactivated and the other set may continue transmitting. In some examples, the column electrodes may be set to receive. In some examples, one set of column electrodes may be ignored while the other set of column electrodes is measured by a controller in communication with the sets of electrodes.

In some examples, each set of column electrodes may be a portion of the capacitance sensor. Each of these portions may be operated independently. For example, if a capacitance sensor has eight column electrodes, the capacitance sensor may have eight portions. If a keyboard input is detected adjacent to the electrode that is furthest left, a controller in communication with the electrodes may change the mode of the electrodes. The electrode that is furthest left may be changed to a mode in which it is least sensitive, and the furthest right column electrode may be changed to a mode in which it is most sensitive. The second column electrode to the left may be switched to a mode in which it is more sensitive than the furthest left column electrode, but less sensitive than the column electrodes to the right of it. Each column electrode may be set to a similar mode, being more sensitive than the column electrodes to the left and less sensitive than the column electrodes to the right.

In some examples, a portion of the capacitance sensor may include row and column electrodes. For example, if a capacitance sensor has eight transmit column electrodes and six sense row electrodes, one portion of the capacitance sensor may have the three column electrodes closest to the left and the two row electrodes closest to the top. In such an example, when a keyboard input is detected adjacent to the top left portion of the capacitance sensor, a controller in communication with the capacitance sensor may deactivate the three transmit column electrodes and ignore the measurements on the two sense row electrodes. In such an example, the five column electrodes closest to the right of the capacitance sensor and the four row electrodes closest to the bottom of the capacitance sensor may continue to operate. While the examples above describe a capacitance sensor with an 8-by-6 mutual capacitance grid, a capacitance sensor with any appropriate number of rows or columns may be used. In some examples, the capacitance sensor 702 may be a capacitance sensor with self-capacitance electrodes.

In some examples, a mode of a portion of the capacitance sensor may cause that a subset of the transmit electrodes do not transmit, that a subset of the sense electrodes does not receive, or combinations thereof. In some examples, the capacitance sensor may include a self-capacitance electrode that operates by transmitting and receiving. In some examples, a mode of a portion of the capacitance sensor may include that a self-capacitance electrode does not transmit and/or does not receive.

In some examples, the mode may cause the controller to ignore touch inputs that are started in the portion of the capacitance sensor where the mode has switched based on the keyboard input. In some examples, if a touch input is started in a portion of the capacitance sensor that is receiving touch inputs and the touch input moves into the other portion with the different mode, the capacitance sensor may continue to track the touch input even though that portion of the capacitance sensor is operating in a different mode. In some examples, the touch input initiated in the first portion is interpreted by the controller to not be palm resting, so when such a touch input continues into the second portion of the capacitance sensor, the controller may continue to interpret the input as it did in the previous portion.

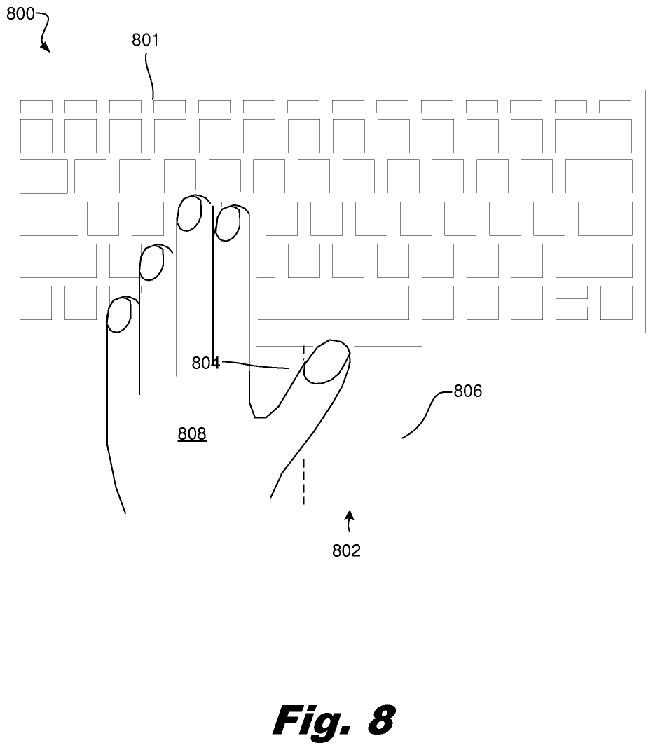

FIG. 8 depicts an example of an electronic device 800. A keyboard 801 is positioned adjacent to a capacitance sensor 802. The capacitance sensor has a first portion 804 and a second portion 806. A hand 808 is positioned adjacent to the capacitance sensor 802 and the keyboard 801. Fingers of the hand 808 are positioned above keys of the keyboard 801. In some examples, the fingers of the hand 808 may press keys of the keyboard 801. In some examples, the palm of the hand 808 may be detected adjacent to the portion 804 of the capacitance sensor 802.

In some examples, a controller in communication with the keyboard 801 and/or the capacitance sensor 802 may determine properties of inputs on the keyboard and/or the capacitance sensor based on measurements on the keyboard and/or capacitance sensor. The controller may determine that the fingers of the hand are adjacent to keys of the keyboard based on keyboard inputs, capacitance measurements, other appropriate measurements, or a combination thereof. The controller may determine that the palm of the hand is adjacent to the portion 804 of the capacitance sensor 802 based on properties of the capacitance measurements on the capacitance sensor. In some examples, the controller may determine that the palm of the hand 808 is adjacent to the capacitance sensor 802 based, at least in part, on the controller determining the position of the fingers of the hand in relation to the keyboard 801 through keyboard inputs. In some examples, the controller detecting the fingers of the hand 808 adjacent to the keys of the keyboard 801 may cause the controller to change the mode of the portion 804 of the capacitance sensor 802. In some examples, detecting the fingers of the hand 808 on specific keys and/or adjacent to a predetermined area of the keyboard 801 may cause the controller in communication with the capacitance sensor to change the portion 804 to a palm rest mode. In such an example, the portion 804 of the capacitance sensor 802 may determine inputs with predetermined properties may be palm inputs. In some examples, determining that an input is a palm may cause the controller to ignore the input or otherwise cause that portion of the capacitance sensor to appear to be deactivated to the user.

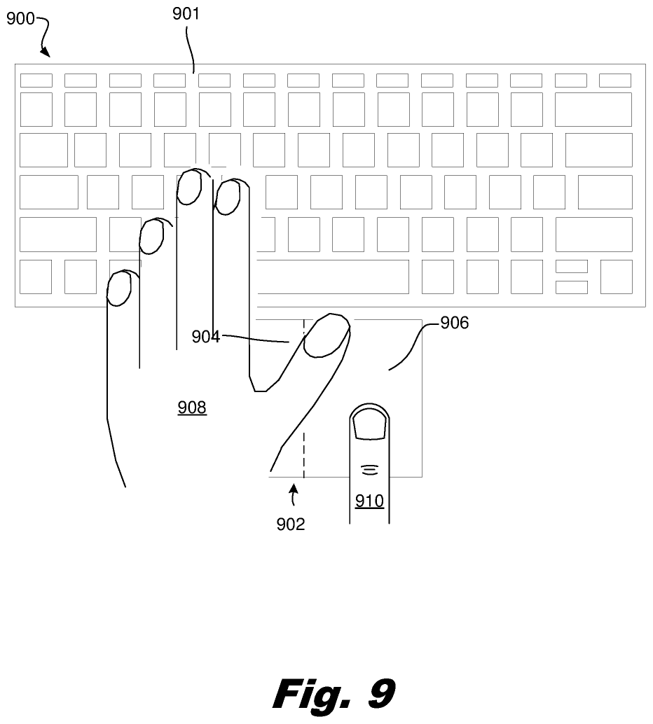

FIG. 9 depicts an example of an electronic device 900. A keyboard 901 is positioned adjacent to a capacitance sensor 902. The capacitance sensor 902 has a first portion 906 and a second portion 908. A hand 908 is positioned adjacent to the keyboard 901 and the first portion 904 of the capacitance sensor 902. A finger 910 is positioned adjacent to the second portion 906 of the capacitance sensor 902. In some examples, fingers of the hand 908 are positioned to provide inputs to the keyboard 901. In some examples, a controller in communication with the capacitance sensor 902 and/or the keyboard 901 may change the modes of the portions 904, 906 of the capacitance sensor 902. In the depicted example, the first portion 904 of the capacitance module 902 may be in a palm rest mode. In some examples, the controller may change the first portion 904 into palm rest mode based, at least in part, on detecting the fingers of the hand 908 being positioned adjacent to certain keys of the keyboard 901. In some examples, the second portion 906 of the capacitance sensor 902 may be in a touch/hover capacitance sensing mode.

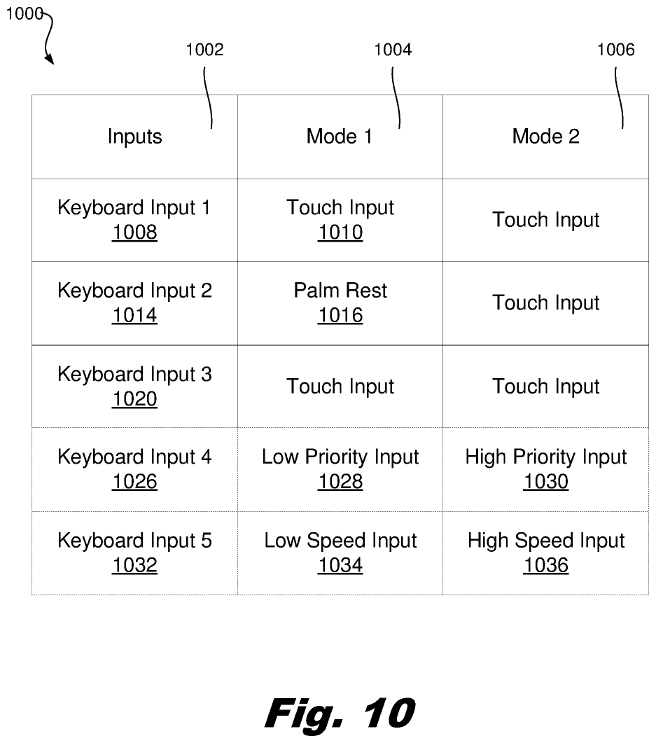

FIG. 10 depicts an example of a mode controller table 1000. In this example, keyboard inputs are represented by an input column 1002. A first mode column 1004 and a second mode column 1006 may represent modes of a first and a second portion of a capacitance sensor, respectively. A first keyboard input 1008 may correspond to an input on the keyboard that is not adjacent to the first or second portions of the capacitance sensor. The modes of the portions of the capacitance sensor may be set by a controller to be in a touch input mode, represented by a touch input mode 1010 on the table 1000. A second keyboard input 1014 may cause the controller to change modes on one of the portions of the capacitance module. This may be in response to detecting the second keyboard input 1014 that may be adjacent to the first portion of the capacitance sensor. The controller may change the first portion of the capacitance sensor to be in a palm rest mode represented by the palm rest mode 1016. The controller may continue to operate the second portion of the capacitance sensor in a touch input mode represented by touch input mode 1010. A third keyboard input 1020 may cause the controller to return the first portion of the capacitance controller to the touch input mode 1010 and may continue to operate the second portion of the capacitance controller in the touch input mode 1010.

In some examples, a controller may change one or both modes of the portions of the capacitance module to other modes. A fourth keyboard input 1026 may cause the controller to change the first portion of the capacitance sensor to be in a low priority mode 1028 and the second portion of the capacitance sensor to be in a high priority mode 1030. In such an example, when multiple inputs are detected in the two portions of the capacitance sensor, the controller may prioritize the input that is on the second portion of the capacitance sensor.

A fifth keyboard input 1032 may cause the controller to change the first portion of the capacitance controller to be operated in a low-speed mode 1034 and the second portion of the capacitance controller to be in a high-speed mode 1036. In such an example, an input on the first portion of the capacitance sensor may be operated at a first sensitivity that is slower than a second sensitivity that the second portion of the sensor is operated. For example, if the capacitance sensor is used to control a cursor in a display, an input on the first portion of the capacitance sensor may move the cursor a shorter distance than a similar input on the second portion of the capacitance sensor.

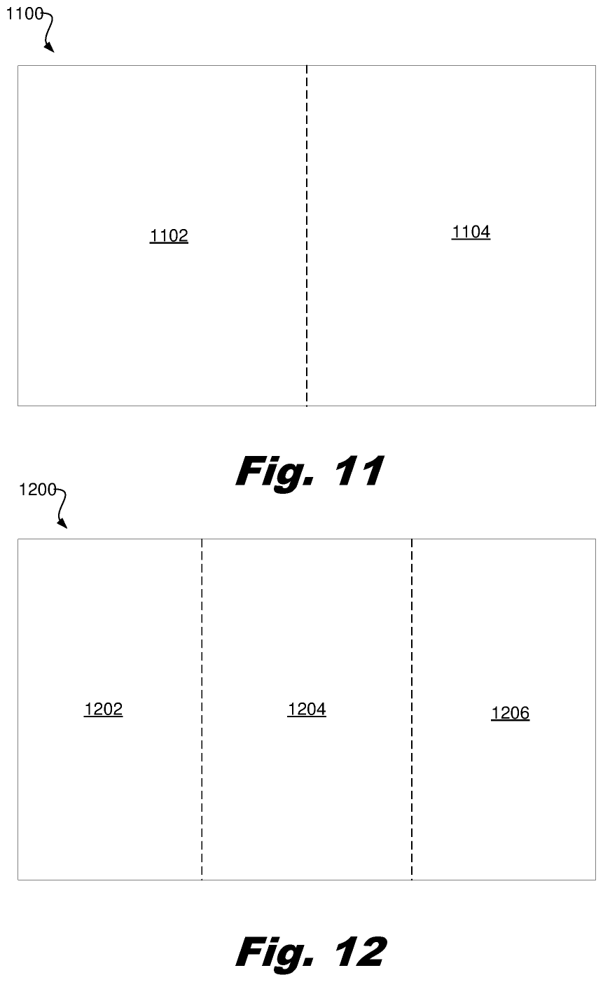

FIG. 11 depicts an example of a capacitance sensor 1100. The capacitance sensor 1100 has a first portion 1102 and a second portion 1104. In some examples, a controller in communication with the capacitance sensor 1100 may operate the portions 1102, 1104 in different modes based on other inputs received by the controller. In some examples, inputs on a keyboard positioned adjacent to the capacitance sensor may be used to determine the modes of the controller.

In some examples, the first and second portions 1102 and 1104 may be combined into a single portion and controlled as a single portion by a controller in communication with the portions. In such an example, the controller may send a signal for the entirety of the capacitance sensor to operate in a specific mode. In some examples, if a keyboard input is detected adjacent to the capacitance sensor, a controller in communication with the capacitance sensor may deactivate the capacitance sensor or ignore all capacitance measurements from the capacitance sensor.

FIG. 12 depicts an example of a capacitance sensor 1200. The capacitance sensor has a first portion 1202, a second portion 1204 and a third portion 1206. The three portions of the capacitance sensor may be operated by a controller in communication with the capacitance sensor. The controller may operate the first portion in a first mode, the second portion in a second mode, and the third portion in a third mode. In some examples where the user is typing on the keyboard, the user's palms may rest over portions 1202 and 1206 that are located on the sides of the capacitance sensor. In such cases, the controller may cause these portions 1202, 1206 to appear as though they are deactivated to the user while allowing the middle portion 1204 to continue to operate in a touch/hover mode.

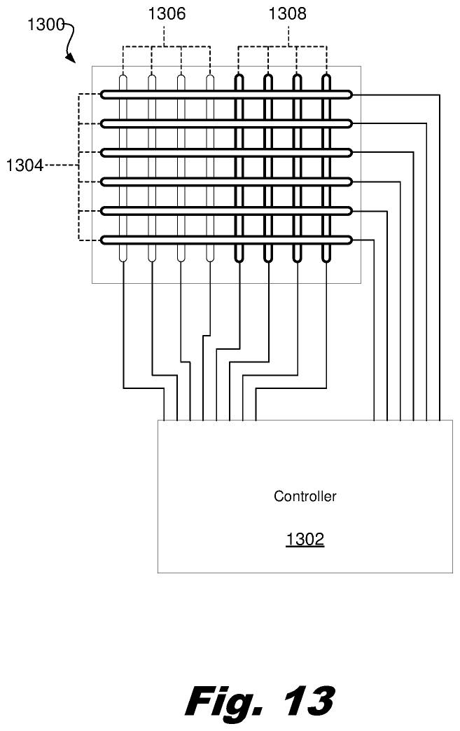

FIG. 13 depicts an example of a capacitance module 1300. A first set of capacitance electrodes is positioned transverse to a second portion 1306 and a third portion 1308 of capacitance electrodes. The portions 1304, 1306, 1308 of capacitance electrodes are in communication with a controller 1302. In some examples, the controller 1302 is in communication with a keyboard. In the depicted example, the portions 1304, 1308 are driven by the controller 1302. In the illustrated example, the portion 1306 of electrodes is deactivated. In some examples, portion 1306 of electrodes may be deactivated based on an input on the keyboard.

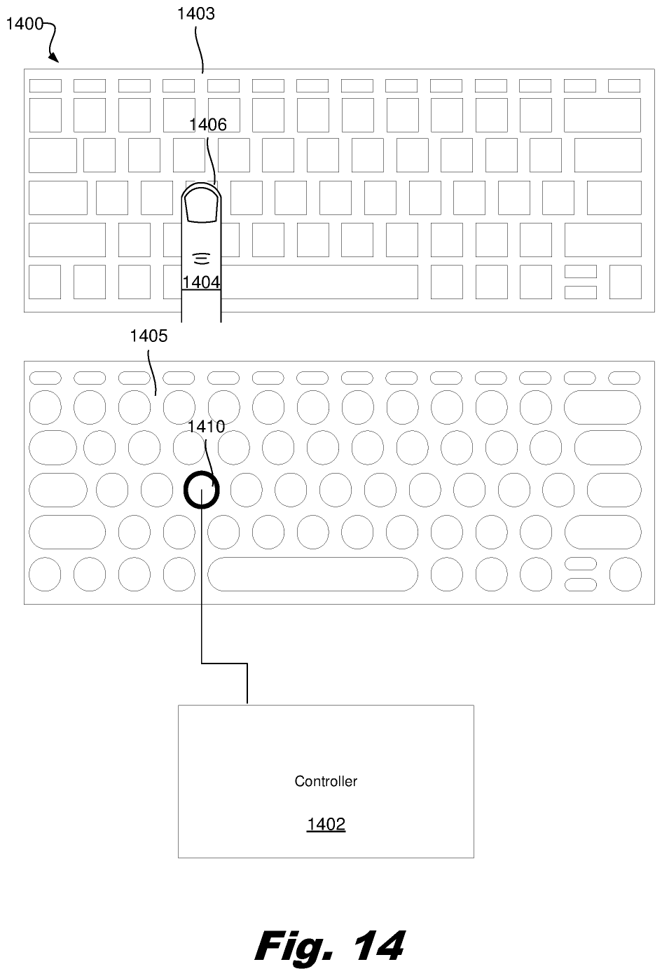

FIG. 14 depicts an example of a keyboard 1400. A finger 1404 is pressing a key 1406 on a first layer 1403 of the keyboard 1400. A contact 1410 is positioned on a second layer 1405 of the keyboard 1400. When the finger presses the key 1406, the key is displaced downward and creates an electrical short with the contact 1410 of the keyboard. A controller 1402 in communication with the keyboard 1400 may measure the change in voltage on the contact 1410 as the key touches the contact. The controller 1402 may determine that the key 1406 is pressed based, at least in part, on the voltage change measured on the contact 1402.

In some examples, the circuity in the first layer 1403 of the keyboard and circuitry in the second layer 1405 of the keyboard may be used to measure a capacitance. This capacitance may change based on the position of a user's finger near the keyboard. This change in capacitance measurements may be used to detect the position of the user's finger. This capacitance input from the keyboard may be received by the controller and be used as a keyboard input to determine when a portion of the capacitance sensor is to change modes.

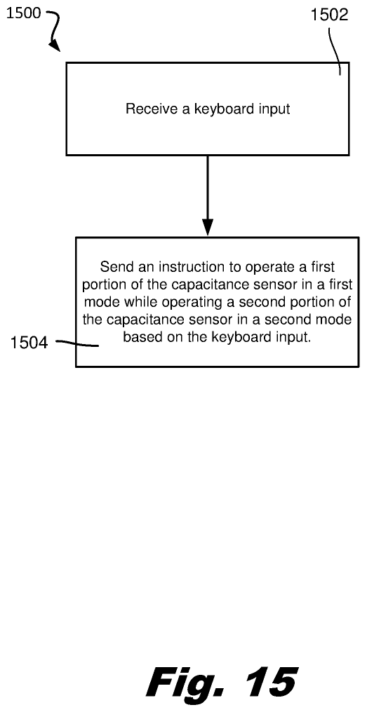

FIG. 15 depicts an example of a method 1500 of changing sensor modes. This method 1500 may be performed based on the description of the devices, modules, and principles described in relation to FIGS. 1-14. In this example, the method 1500 includes receiving 1502 a keyboard input, and sending 1504 an instruction to operate a first portion of a capacitance sensor in a first mode while operating a second portion of the capacitance sensor in a second mode based on the keyboard input.

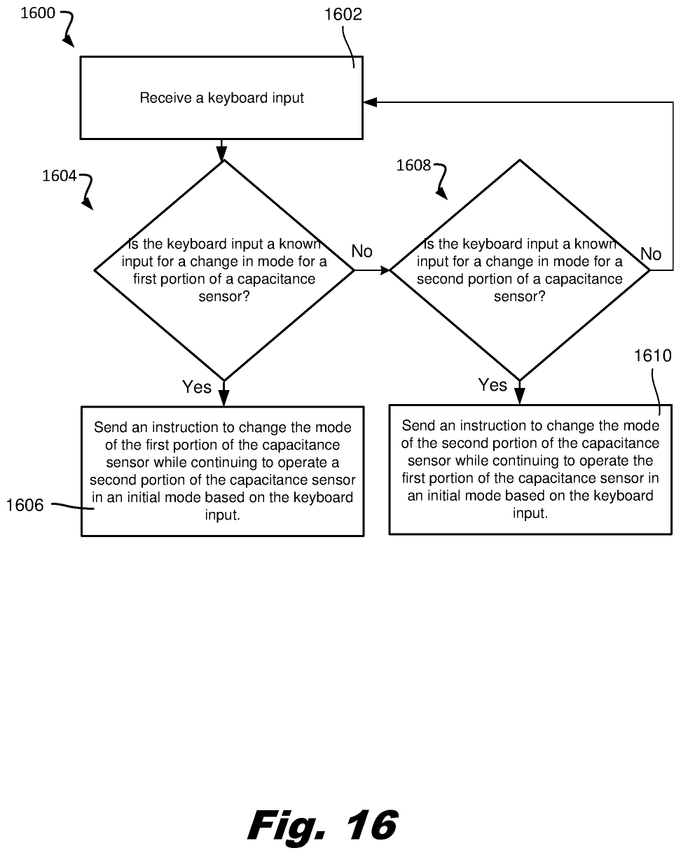

FIG. 16 depicts an example of a method 1600 of changing sensor modes. This method 1600 may be performed based on the description of the devices, modules, and principles described in relation to FIGS. 1-14. In this example, the method 1600 includes receiving 1602 a keyboard input and determining 1604 if the keyboard input is a known input for a change in mode for a first portion of a capacitance sensor. If the keyboard input is a known input for a change in the first portion of the capacitance sensor, the method 1600 also includes sending 1606 an instruction to change the mode of the first portion of the capacitance sensor while continuing to operate a second portion of the capacitance sensor in an initial mode based on the keyboard input. If the keyboard input is not a known input for a change in the first portion of the capacitance sensor, the method 1600 includes determining 1608 if the keyboard input is a known input for changing a second portion of the capacitance sensor. If the keyboard input is a known input for changing the second portion of the capacitance sensor, the method 1600 includes 1610 sending an instruction to change the mode of the second portion of the capacitance sensor while continuing to operate the first portion of the capacitance sensor in an initial mode based on the keyboard input.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1. A capacitance module, comprising:
a substrate;
a plurality of capacitance electrodes on the substrate to form a capacitance sensor;
the plurality of capacitance electrodes in communication with a controller;
memory in communication with the controller having programmed instructions that, when executed, cause the controller to:
receive a keyboard input from a keyboard in communication with the controller; and
operate a first portion of the capacitance sensor in a first mode while operating a second portion of the capacitance sensor in a second mode based on the keyboard input;
wherein the first mode causes a capacitance measurement to be interpreted differently than how the capacitance measurement is interpreted under the second mode;
wherein the first mode causes the capacitance measurement to be interpreted as a palm resting, whereas the capacitance measurement is interpreted as a touch input in the second mode.

2. The capacitance module of claim 1, wherein the first mode is an inactive mode and the second mode is an active mode.

3. (canceled)

4. (canceled)

5. The capacitance module of claim 1, wherein the keyboard is a mechanical switch keyboard; and
wherein a location of the keyboard input is determined with a capacitance measurement made with a circuit incorporated into a first layer of the keyboard and a second layer of the keyboard.

6. The capacitance module of claim 1, wherein the programmed instructions are further configured, when executed, to turn at least one of the plurality of capacitance electrodes off.

7. The capacitance module of claim 1, wherein the programmed instructions are further configured, when executed, to cause the controller to ignore measurements from at least one of the plurality of capacitance electrodes.

8. The capacitance module of claim 1, wherein the plurality of capacitance electrodes has a first group of electrodes and a second group of electrodes; and
the first group of electrodes and the second group of electrodes are controlled independently with the controller.

9. The capacitance module of claim 1, wherein the keyboard input is a capacitive keyboard input.

10. The capacitance module of claim 1, wherein the keyboard input is a mechanical switch keyboard input.

11. The capacitance module of claim 1, wherein the first portion and the second portion of the capacitance sensor area are a part of a plurality of portions of the capacitance sensor; and
the plurality of portions are operated in a plurality of modes based, at least in part, on the keyboard input.

12. A computer-program product for using a module, the computer-program product comprising a non-transitory computer-readable medium storing instructions executable by a processor to:
receive a keyboard input; and
send an instruction to operate a first portion of a capacitance module in a first mode while operating a second portion of the capacitance module in a second mode based on the keyboard input;
wherein the first mode causes a capacitance measurement to be interpreted differently than how the capacitance measurement is interpreted under the second mode;
wherein the first mode causes the capacitance measurement to be interpreted as a palm resting, whereas the capacitance measurement is interpreted as a touch input in the second mode.

13. (canceled)

14. (canceled)

15. The computer-program product of claim 12, wherein the keyboard input is based on a capacitance measurement made with a circuit incorporated into a first layer of the keyboard and a second layer of the keyboard;
wherein the keyboard is a mechanical switch keyboard.

16. A method, comprising:
receiving a keyboard input; and
sending an instruction to operate a first portion of a capacitance module in a first mode while operating a second portion of the capacitance module in a second mode based on the keyboard input;
wherein the first mode causes a capacitance measurement to be interpreted differently than how the capacitance measurement is interpreted under the second mode;
wherein the first mode causes the capacitance measurement to be interpreted as a palm resting, whereas the capacitance measurement is interpreted as a touch input in the second mode.

17. (canceled)

18. (canceled)

19. The method of claim 16, wherein the keyboard input is based on a capacitance measurement made with a circuit incorporated into the keyboard.

20. The method of claim 19, wherein the keyboard input is based on an electrical shorting measurement made with a circuit incorporated into the keyboard.

21. The capacitance module of claim 1, wherein receiving a keyboard input includes receiving the keyboard input for a predetermined amount of time.

22. The capacitance module of claim 1, wherein receiving a keyboard input includes receiving multiple keyboard inputs.
